(19) United States
(12) Patent Application Publication
(10) Pub. No.: US 2022/0213918 A1
(43) Pub. Date: Jul. 7, 2022

(54) Dual Head Screw

(71) Applicant: Jeffrey Holland, Arkansaw, WI (US)

(72) Inventor: Jeffrey Holland, Arkansaw, WI (US)

(21) Appl. No.: 17/345,620

(22) Filed: Jun. 11, 2021

Related U.S. Application Data
(60) Provisional application No. 63/134,385, filed on Jan. 6, 2021.

(51) Int. Cl. F16B 23/00

(52) U.S. Cl. CPC F16B 23/0092; F16B 23/0046; F16B 23/0038

(57) ABSTRACT

This present invention relates to a dual head screw that features at least one male nut driver extending outwardly from a base head opposite the shaft of the screw. The dual head screw replaces standard female head screws, thus eliminating concern over stripping of the screw head or the same becoming compacted with debris. The dual head screw has a shaft with a threaded section, a base head and the male nut driver. The male nut driver is dimensioned in size to withstand the torsional forces associated with installing or extracting the dual head screw from an object, and may be driven or extracted with a standard hand tool or a power drill. In a further embodiment, the male nut driver may be comprised of a first driving portion and a second driving portion.

### CROSS-REFERENCE TO RELATED APPLICATION

The present application claims priority to, and the benefit of, U.S. Provisional Application No. 63/134,385, which was filed on Jan. 6, 2021 and is incorporated herein by reference in its entirety.

### FIELD OF THE INVENTION

The present invention relates generally to the field of double-headed fasteners. More specifically, the present invention relates to a screw featuring a male nut driver head or end that extends outwardly from the seated head. The screw replaces double-headed nails and standard female head screws, thereby eliminating the problems associated with the female head becoming stripped and/or getting filled with dirt and debris, which can make it difficult to install or retract. The uniquely designed screw allows a female-style nut driver tool having a square or torque-style head that can fit over the screw to be used for application and removal of the screw. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, fasteners and screws, and double-headed nails in particular, are commonly used in various construction-related tasks, such as attaching a first object to a second object, bracing of a constructed wall to be kept level, footings with stakes, kickers and spreaders, concrete forms where basements are being poured, slab on grade forms, etc. Typically, such double-headed nails are comprised of a nail portion, a first head portion and a second head portion, positioned inwardly from the first head portion and along the nail portion. Such nails are commonly driven into an object by striking the first head portion with a tool, such as a hammer, until such time that the second head is relatively flush with the outer surface of the object into which the nail is being driven. Upon such installation, the first head portion remains extended outwardly from the second head portion, and is useful for extracting the nail with, for example, a claw-like hammer or roofing bar. These types of nails are particularly useful as temporary fasteners that will eventually be removed after having served their purpose. However, such nails are also time consuming and laborious to install and extract, thereby making their usefulness somewhat limited. Further, such nails, lacking any threads, oftentimes become prematurely loose or begin to back out of the object to which they were initially driven into, thereby failing to serve their purpose over time.

Similarly, female-headed screws have an elongated body portion having a relatively sharp or pointed tip at a distal end that can be inserted into an object, such as wood, and a head structure for driving or retracting the screw into and out of the object. The body portion is typically comprised of a cylindrical or tapered core, having a helical thread along its exterior surface and either a variable or a constant major diameter extending along the entire length of the screw or a partial length of the screw. The head structure is positioned at a proximal end of the screw (i.e., the end nearest the individual driving/retracting the screw), and is typically a female-type structure having an opening therein that is capable of receiving or matingly engaging with a corresponding male driver portion.

Unfortunately, given the amount of torsional forces that are required to drive or retract the screw from an object, the female structure can become worn or stripped over time, thereby making it impossible to further utilize the male driver portion to insert or retract the screw from the object. Further, while using such screws during construction-related tasks and for other similar purposes, the female head may also become filled with debris such as, but not limited to, dirt, concrete, mud, etc., thereby making it difficult to apply a male driver from a hand tool or power drill to the screw. In such scenarios, the screw becomes inaccessible to the user. Individuals may then attempt to remove the obstruction, but doing so, particularly removing those female portions of a screw filled with concrete, can be both time consuming and laborious.

Therefore, there exists a long felt need in the art for a modified screw structure that allows the screw to be driven and/or extracted using a female nut driver or other tool, and that can be used for various purposes such as, but not limited to, fastening a first object to a second object, creating bracing for a constructed wall to be kept level, footings with stakes, kickers and spreaders, concrete forms where basements are being poured, slab on grade forms, etc. Additionally, there is a long felt need in the art for a modified screw structure that is easily accessible at all times, and that will not become filled with debris such as, but not limited to, dirt, concrete, mud or the like, thereby making it difficult or impossible to use. Moreover, there is a long felt need in the art for a modified dual-headed screw structure that will not easily strip or become worn over time when repeatedly used with a driver device, and that will not prematurely back out of the object into which it was driven. Finally, there is a long felt need in the art for a modified screw structure that is relatively inexpensive to manufacture, and that is both safe and easy to use.

The subject matter disclosed and claimed herein, in one embodiment thereof, comprises a double or dual-headed screw having a shaft with a plurality of threads positioned along the exterior of the surface of the shaft in a helical fashion, a base head and a male nut driver member. The base head is comprised of two surfaces, wherein the shaft is joined to the first surface and the male nut driver member is joined to the second opposing surface. The male nut driver member is a generally square or torque-style head that extends outwardly from the second surface and replaces the standard female head screw opening. The male nut driver member can fit in a female driver of a standard hand tool or a power drill for application and removal of the double head screw. The double head screw may replace both a double head nail and a conventional screw.

In this manner, the novel dual head screw structure of the present invention accomplishes all of the forgoing objectives, and provides a relatively convenient and efficient solution to the myriad of problems associated with prior art double-headed nails and standard construction screws. The dual head screw of the present invention is also user friendly, as it is relatively easy to install and/or extract, and does not easily strip with repeated use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a double head screw having a thread section, a shaft, a base head and a male nut driver member. The base head having two opposing surfaces, wherein the shaft is joined to, and extends outwardly from, a first surface, and the male nut driver member is joined to, and extends outwardly from, a second surface. The thread section comprises a plurality of threads along an elongated axis and positioned on an external surface of the shaft. The male nut driver member is preferably a substantially square or torque-style head, and replaces a standard female head screw. The male nut driver member can fit in a female driver of a standard hand tool or a power drill for application and removal of the double head screw in an object or through a surface.

In a further embodiment of the present invention, an improved screw designed to replace a standard female head screw and to function as a securement screw in a plurality of construction and joining tasks is disclosed. The improved screw comprises an integrally formed shaft and a substantially square or torque-style head attached to a base head that is in turn attached to the shaft, wherein the square head extends outwardly from a first surface of the base head, and the shaft extends outwardly from a second surface of the base head that is opposite the first surface. The square head is capable of being matingly engaged by a female bit or attachment of at least one of a nut driver tool, a nut driver drill bit or a power drill for the purposes of driving or retracting the improved screw from an object or a surface. The shaft of the improved screw further comprises a threaded section having a plurality of threads positioned along an exterior surface of the shaft in a helical fashion and at a desired pitch and/or thread count. In use, the improved screw of the present invention is inserted into a surface until the second surface of the base head contacts the exterior surface of the object into which it is being driven.

The primary advantage of the dual head screw of the present invention is that it replaces the standard female head screws, which tend to strip over time and/or become clogged or compacted with concrete, dirt and other debris, thereby rendering the same useless. The dual head screw of the present invention may be applied with a standard hand tool or a power drill without concern for stripping or the screw head becoming filled or caked with debris. The dual head screw of the present invention also eliminates the need for a user to use a nut driving bit to engage a nut-driving screw.

In all embodiments, the dual head screw comprises a male member that extends outwardly from a base head and whose size, shape and/or diameter may change as per the requirements of the user. The size, type and pitch of the thread section of the shaft of the screw may also be altered. The dual head screw may be used for any type of construction project including, without limitation, log home construction, forms for concrete walls and other structures, barn construction and any other task that requires the securement of a first object to a second object. Further, the dual head screw of the present invention is also useful for hanging picture frames and other objects on a wall, as further described below.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a dual-headed screw of the present invention in accordance with the disclosed architecture;

FIG. 2A illustrates a top perspective view of one potential embodiment of the dual-headed screw of the present invention in accordance with the disclosed architecture;

FIG. 2B illustrates a top perspective view of another potential embodiment of the dual-headed screw of the present invention in accordance with the disclosed architecture, wherein the male nut driver is comprised of a first cross-section and a second cross-section that differs from the first cross-section;

FIG. 3 illustrates a perspective view of one potential embodiment of the dual-headed screws of the present invention being installed into wooden forms using a handheld nut driver tool in accordance with the disclosed architecture;

FIG. 4 illustrates a perspective view of various different sizes of one potential embodiment of a dual-headed screw of the present invention in accordance with the disclosed architecture;

FIG. 5 illustrates a perspective view of one potential embodiment of a dual-headed screw of the present invention installed into a wall in accordance with the disclosed architecture;

FIG. 6 illustrates a perspective view of one potential embodiment of the dual-headed screws of the present invention being installed into wooden forms using a power drill in accordance with the disclosed architecture;

FIG. 7 illustrates a perspective view of one potential embodiment of the dual-headed screw of the present invention removably attached to a power drill and about to be installed into a wooden form in accordance with the disclosed architecture; and

FIG. 8 illustrates a perspective view of one potential embodiment of a dual-headed screw of the present invention in accordance with the disclosed architecture, wherein the male nut driver further comprises a groove therein.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a modified screw structure that allows the screw to be driven and/or extracted using a female nut driver or other tool, and that can be used for various purposes such as, but not limited to, fastening a first object to a second object, creating bracing for a constructed wall to be kept level, footings with stakes, kickers and spreaders, concrete forms where basements are being poured, slab on grade forms, etc. Additionally, there is a long felt need in the art for a modified screw structure that is easily accessible at all times, and that will not become filled with debris such as, but not limited to, dirt, concrete, mud or the like, thereby making it difficult or impossible to use. Moreover, there is a long felt need in the art for a modified dual-headed screw structure that will not easily strip or become worn over time when repeatedly used with a driver device, and that will not prematurely back out of the object into which it was driven. Furthermore, there is a long felt need in the art for a modified dual-headed screw structure that can be driven or extracted with a plurality of different drivers, thereby increasing its functionality and versatility. Finally, there is a long felt need in the art for a modified screw structure that is relatively inexpensive to manufacture, and that is both safe and easy to use.

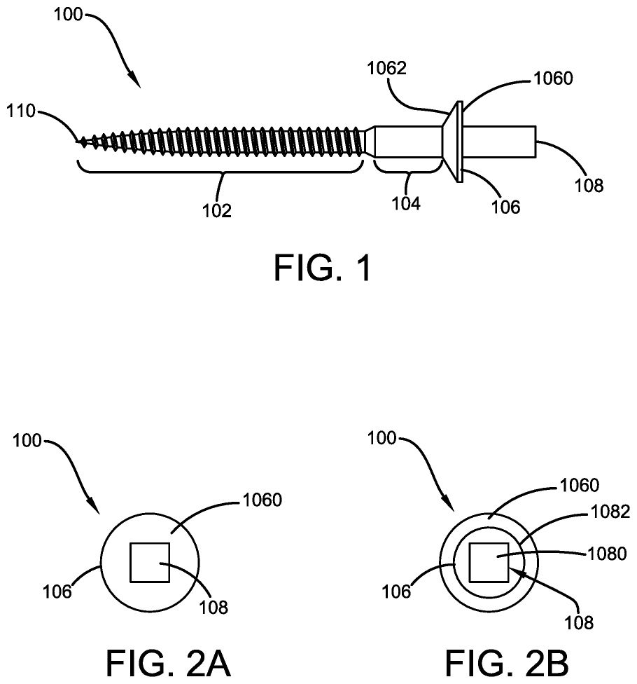

Referring initially to the drawings, FIG. 1 illustrates a perspective view of one potential embodiment of the double-head screw 100 of the present invention as per the disclosed structure. Generally stated, the double-head screw 100 is comprised of a shaft 104, a base head 106 and a male nut driver 108, wherein each of the shaft 104, the base head 106 and the male nut driver 108 is unitary in construction. More specifically, the base head 106 is comprised of a first surface 1060 and a second surface 1062 that is opposite of the first surface 1060. The male nut driver 108 is positioned on, and extends outwardly from, the first surface 1060 of the base head 106, and the shaft 104 is positioned on, and extends outwardly from, the second surface 1062 in a direction that is opposite of the male nut driver. Nonetheless, each of the shaft 104, base head 106 and the male nut driver 108 share a common longitudinal center axis.

The double-headed screw 100 and its various components may be comprised of a galvanized steel, a mild steel for heavy load operations such as drilling into concrete, a plastic, lightweight metal, or any other suitable material and may also be manufactured using additive manufacturing techniques. The double-head screw 100 may be used for construction, landscaping and the like, and is compatible with all forms of building materials including, without limitation, concrete, wood, plastic, etc.

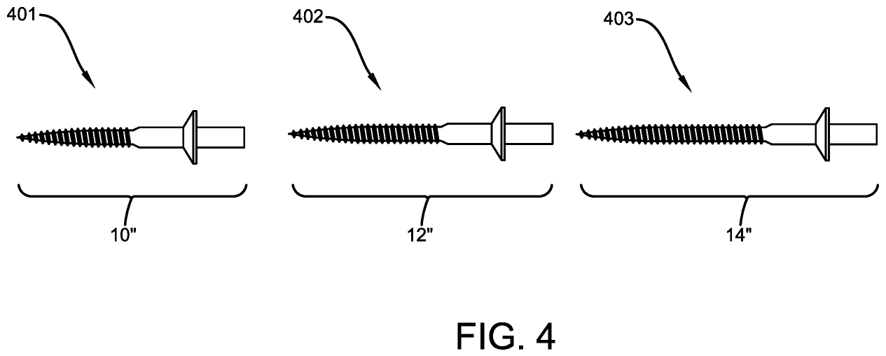

As best shown in FIGS. 1 and 4, the shaft 104 of the double-headed screw 100 further comprises a threaded portion 102 along its exterior surface that is comprised of a plurality of threads 1020 in a helical arrangement, which is used for screwing the screw 100 into a surface. The outside diameter of the threads 1020 in the threaded section 102 taper from a smaller diameter near the leading end or penetrating tip 110 of the shaft 104 to a larger diameter towards where the shaft 104 meets the head base 106. Furthermore, the pitch of the threads 1020 near the penetrating tip 110 may be more than the pitch of the threads 1020 near the head base 106. Alternatively, the pitch of the thread revolutions may be constant along the threaded portion 102. Also, the threaded portion 102 of the screw 100 may extend along the entire length of the shaft 104, or only a portion thereof, depending upon the needs and/or preferences of the user. Any portion of the shaft 104 that is not consumed or covered by the threaded portion 102, is relatively smooth, plain and unthreaded.

In one embodiment, the double-head screw 100 preferably has roughly the same dimensions (i.e., length, thickness, etc.) of conventional double-head nails and/or female headed screws. However, in the present embodiment, the male nut driver 108 has a substantially square cross-section and a width or diameter that is larger than a diameter of the shaft 104, but less than the diameter of the head base 106. Nonetheless, the screw device 100 of the present invention is not so limited, and the male nut driver 108 may be of any shape or size that accommodates user need and/or preference and that is capable of withstanding/exerting the torsional forces necessary to repeatedly drive/insert or withdraw/extract the shaft portion 104 of the dual-headed screw 100 into an object without failing or stripping. A explained more fully below, the screw 100 may be driven into, or extracted from, an object with a hand or power-driven tool or implement.

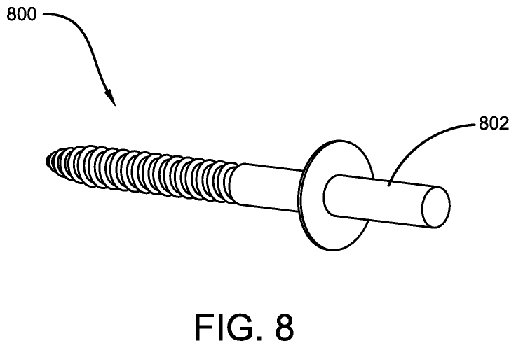

FIG. 2A illustrates a top perspective view of one potential embodiment of the dual-headed screw 100 of the present invention in accordance with the disclosed architecture. As shown, the male nut driver 108 has a substantially square-shaped cross section. However, the present invention is not so limited, and many other cross-sectional shapes are also contemplated such as, but not limited to, a circle (as best shown in FIG. 8), a triangle, a hexagon, pentagon, star shaped, etc. As previously stated, the male nut driver 108 is preferably integrally formed with, and extends outwardly from, the first surface 1060 of the base head 106. Nonetheless, it is also contemplated that the male nut driver 108 could be removably or fixedly attached to the first surface 1060 of the base head 106 in other embodiments of the present invention. The male nut driver 108 is dimensioned to matingly engage with a female-style nut driver tool (hand or electrically-powered) having a square head for application and removal of the dual-headed screw 100. Experimental use has proven that the substantially square male member 108 is less prone to cam-out or stripping than other configurations, and allows for a secure manual or automated operation with the double-head screw 100. In one embodiment, the double-head screw 100 of the present invention may be used along with temporary steel stakes or oxy wood stakes in a construction project, and the double-head screw 100 may be driven through the wood and/or into the ground with an SDS max/spline or SDS-style hammer drill.

FIG. 2B illustrates a top perspective view of another potential embodiment of the dual-headed screw 100 of the present invention in accordance with the disclosed architecture, wherein the male nut driver 108 is comprised of a first cross-section 1080 and a second cross-section 1082 that differs from the first cross-section. More specifically, the outermost portion of the male nut driver 108, meaning the portion of the male nut driver 108 furthest away from the first surface 1060 of the base head 106, may be the substantially square male member 108 described above, and the innermost portion of the male nut driver 108, meaning the portion of the male nut driver 108 closest to the first surface 1060 of the base head 106, may have a second cross-section 1082 such as, but not limited to, a circle (as best shown in FIG. 8), triangle, hexagon, pentagon, star-shaped, etc. Importantly, the size and shape of the second cross-section 1082 of the male nut driver 108 should be such that the same may be accessed by a handheld or electrically-powered screw driving tool without interference from the first cross-section portion 1080 of the male nut driver 108 (e.g., it should be larger than the first cross-section portion 1080).

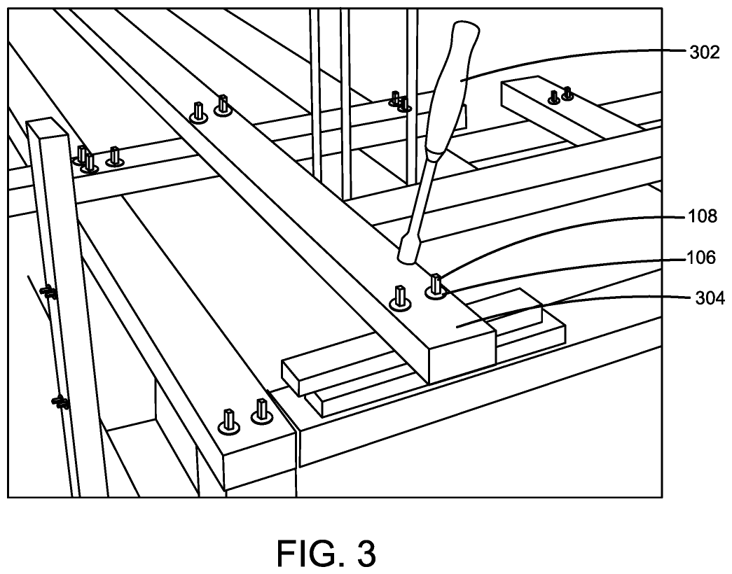

FIG. 3 illustrates a perspective view of one potential embodiment of the dual-headed screws 100 of the present invention being installed into wooden forms 304 using a handheld nut driver tool 302 in accordance with the disclosed architecture. The advantage of the double-headed screw 100 of the present invention is that it can be applied to a variety of surfaces and materials including, without limitation, concrete, plastic, wood, floors, walls, structures, objects and any other surface.

For example, in FIG. 3, the male nut driver 108 may be inserted into a female-type of driver 302 and then easily and conveniently applied into a surface of the wood forms 304. More specifically, the penetrating tip 110 and threaded portion 102 of the shaft 104 of double-head screw 100 drills through the surface of the wood forms 304 until the second surface 1062 of the base head 106 is in contact with the wood form 304. The male nut driver 108 extends outwardly from the first surface 1060 of the base head 106, which allows the screw to be easily extracted with the same driver 302 when the same is no longer needed. The double-head screw 100 is an ideal and more useful replacement of a double-headed nail.

FIG. 4 illustrates a perspective view of various different sizes of one potential embodiment of a dual-headed screw of the present invention in accordance with the disclosed architecture. More specifically, the double-head screw of the present invention may come in a variety of different sizes and diameters to satisfy user need and/or preference, or to suit a particular application. The double-head screw may replace conventional single and double-headed nails, as well as female opening-type screws. For example, in one embodiment, a double-head screw 401 may have a total length of approximately 10″ from the leading edge/penetrating tip 110 of the threaded portion 102 to the outermost edge of the male nut driver 108. In a further embodiment, a larger sized double-head screw 402 may have a total length of approximately 12″ from the leading edge 110 of the threaded portion 102 to the outermost edge of the male nut driver 108. In a still further embodiment, an even larger double-head screw 403 may have a total length of approximately 14″ from the leading edge 110 of the threaded portion 102 to the outermost edge of the male nut driver 108. In still other embodiments, the length of the double-head screw 100 may be similar to standard double-head nails and may be 2″, 2½″, 3″ or 3½″ long for example. As stated above, the double-head screw 100 may be comprised of galvanized steel, ionized steel, metal, plastic or any other suitable material that satisfies the requirements of the user or a particular application.

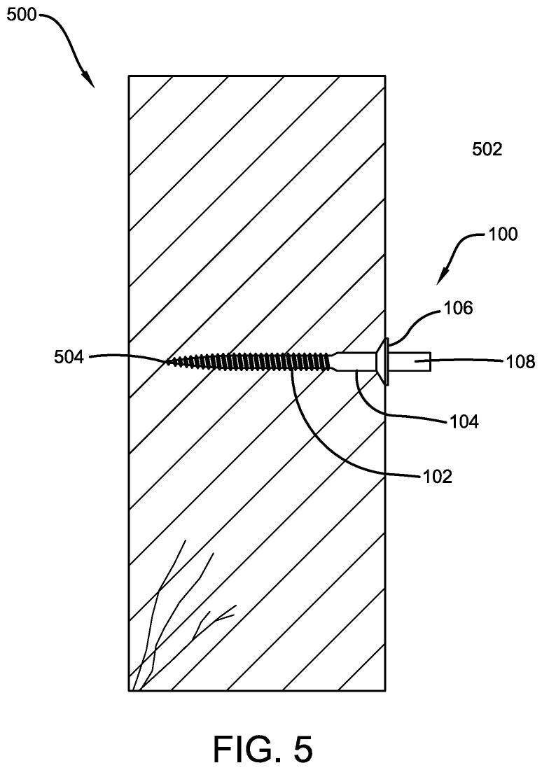

FIG. 5 illustrates a perspective view of one potential embodiment of a dual-headed screw 100 of the present invention installed into a wall 500 in accordance with the disclosed architecture. More specifically, the leading edge or penetrating tip 110 of the threaded section 102 may be positioned immediately adjacent to a surface 502 of the wall 500, and a relatively light impact or force is applied to the male-driving member via a hammer, nut driver or even the user's hand to create an opening or hole 504 on the surface 502. The threaded section 102 of the screw 100 may then be drilled into the wall 500 along with the shaft section 104, until the second surface 1060 of the base head 106 of the double-head screw 100 rests on the surface 502 of the wall 500.

Any type of female-style nut driver tool with a square or torque-style head that can fit over the male member 108 of the double-head screw 100 is appropriate for application and removal. It should be appreciated that the double-head screw 100 replaces the standard female head screws, thereby eliminating the historical problems of the same becoming stripped and/or filled with dirt and debris. The double-head screw 100 of all the embodiments of the present invention may function as a securement screw in numerous construction projects such as bracing walls, securing kickers for a footing, and much more.

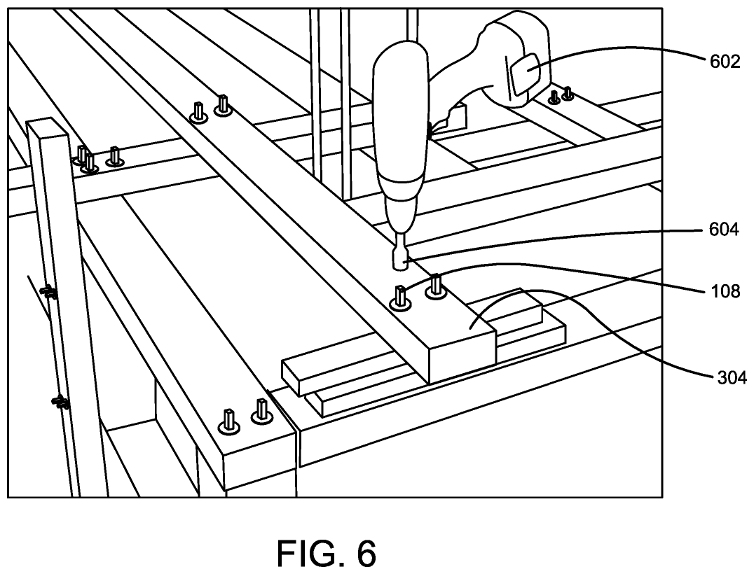

FIG. 6 illustrates a perspective view of one potential embodiment of the dual-headed screws 100 of the present invention being installed into wooden forms 304 using a power drill 602 in accordance with the disclosed architecture. More specifically, to insert the double-head screw 100 of the present invention into the wooden forms 304, a female nut driver drill bit 604 installed on a nut driver or power tool 602 is positioned over top and around the male nut driver head 108 that extends outwardly from the first surface 1060 of the base head 106. The drill 602 is then used to rotate the screw 100 in a clockwise direction and drive the same, with the help of the penetrating tip 110 and the threaded portion 102, into the wooden forms 304 until such time that the second surface 1062 of the base head 106 of the double-head screw 100 rests on the surface of the wooden form 304. The female nut driver drill bit 604 may be square-shaped, torque-shaped or of any other shape that is capable of fitting over and around the male member 108 to create a secure fit.

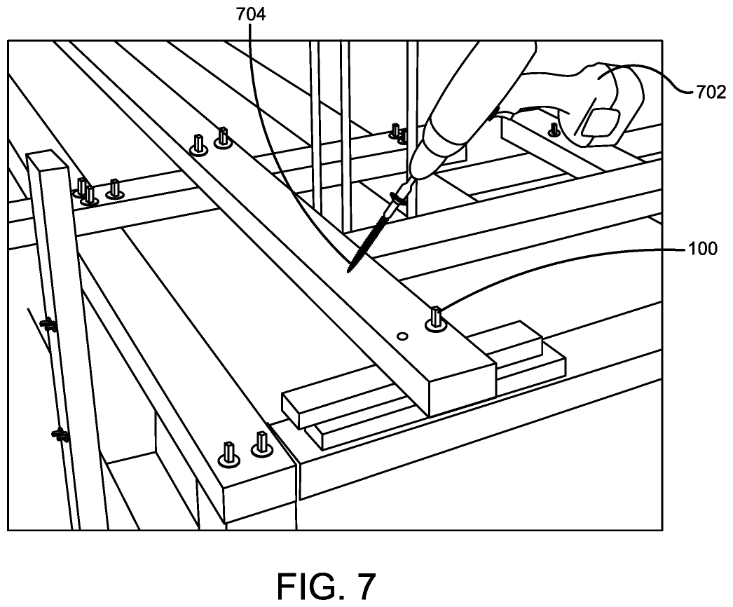

FIG. 7 illustrates a perspective view of one potential embodiment of the dual-headed screw 100 of the present invention removably attached to a power drill 702 and about to be installed into a wooden form 304 in accordance with the disclosed architecture. More specifically, the double-head screw 100 may be applied with a power drill 702 using a power drill bit 704 without worry of the screw head getting filled or caked with debris. The bit 704 is designed to accommodate the screw head and drill into a surface. The drill bit 704 may have a square, torque-based, or any other suitably shaped opening for receipt of the male nut driver 108.

FIG. 8 illustrates a perspective view of one potential embodiment of a dual-headed screw 800 of the present invention in accordance with the disclosed architecture, wherein the male nut driver portion 802 is a torque-style head and further comprises a groove 803 therein. More specifically, the remaining portions of the screw 800 (i.e., threaded portion 102, shaft 104, head base 106, etc.) are the same or substantially similar to those of the screw 100 described above. However, in the present embodiment, the improved screw 800 has a torque-style head 802 that may be easily engaged by a conventional hand tool or a power drill.

The torque style head 802 has the same properties and characteristics of the square male member 108 of the other embodiments of the present invention described above, and offers the same utility and convenience to a user while applying or removing the screw 100, 800. The double-head screw 100, 800 of the present invention can be used for additional purposes such as for hanging items such as pictures, shovels, brooms, rakes, coats, etc. and can be used to press fit different objects to it. For example, the presence of the groove 803 may be used to press fit, for example, a picture frame or other object thereon if the screw 800 is driven into a wall as described above. Further, if the screw has first and second cross sections 1080, 1082 as described above, the groove 803 is preferably positioned between the first cross section 1080 and the second cross section 1082. Nonetheless, the screw of the present invention is not so limited and the groove 803 may be positioned anywhere along the first or second cross sections 1080, 1082.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “double-head screw”, “screw”, “improved screw”, and “screw with male head member” are interchangeable, and refer to the dual-head screw 100, 800 of the present invention.

Notwithstanding the forgoing, the dual-head screw 100, 800 of the present invention and its various components can be of any suitable size and configuration as is known in the art without affecting the overall concept of the invention, provided that the same accomplish the above-stated objectives. One of ordinary skill in the art will appreciate that the size, configuration and material of the dual-head screw 100, 800 as shown in the FIGS. are for illustrative purposes only, and that many other sizes and shapes of the dual-head screw 100, 800 are well within the scope of the present disclosure. Although the dimensions of the dual-head screw 100, 800 are important design parameters for user convenience, the dual-head screw 100, 800 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dual head screw comprising:
a shaft;
a base head; and
a male nut driver.

2. The dual head screw of claim 1, wherein the base head comprises a first surface and a second surface, and further wherein the second surface is opposing to the first surface.

3. The dual head screw of claim 2, wherein shaft extends outwardly from the first surface and the male nut driver extends outwardly from the second surface.

4. The dual head screw of claim 2, wherein the base head has a diameter that is larger than a diameter of the shaft.

5. The dual head screw of claim 3, wherein the male nut driver is smaller than the diameter of the base head but larger than the diameter of the shaft.

6. The dual head screw of claim 5, wherein the shaft comprises a threaded portion.

7. The dual head screw of claim 6, wherein the shaft comprises a penetrating tip.

8. The dual head screw of claim 7, wherein shaft has a taper such that the diameter of the shaft is smaller near the penetrating tip than the diameter of the shaft near the base head.

9. The dual head screw of claim 8, wherein the male nut driver has a substantially square cross-section.

10. The dual head screw of claim 8, wherein the male nut driver has a substantially circular cross-section.

11. A dual head screw comprising:
a shaft;
a base head; and
a male nut driver, wherein the male nut driver has a first cross-section and a second cross-section.

12. The dual head screw of claim 11, wherein the base head comprises a first surface and a second surface, and further wherein the second surface is opposing to the first surface.

13. The dual head screw of claim 12, wherein shaft extends outwardly from the first surface and the male nut driver extends outwardly from the second surface.

14. The dual head screw of claim 13, wherein the base head has a diameter that is larger than a diameter of the shaft, and further wherein the male nut driver is smaller than the diameter of the base head but larger than the diameter of the shaft.

15. The dual head screw of claim 14, wherein the shaft comprises a threaded portion and a penetrating tip.

16. The dual head screw of claim 15, wherein shaft has a taper such that the diameter of the shaft is smaller near the penetrating tip than the diameter of the shaft near the base head.

17. The dual head screw of claim 16, wherein the male nut driver further comprises a groove.

18. The dual head screw of claim 17, wherein the groove is positioned between the first cross-section and the second cross-section.

19. The dual head screw of claim 17, wherein the groove is positioned along either the first cross-section or the second cross-section.

20. A dual head screw comprising:
a base head;
a tapered shaft extending outwardly from a first surface of the base head, wherein a diameter of the tapered shaft becomes smaller the farther away from the base head;
a plurality of threads positioned along at least a portion of an exterior surface of the tapered shaft; and
a male nut driver, wherein the male nut driver has a first cross-section and a second cross-section, and further wherein the first cross-section is different than the second cross-section.
